(19) United States
(12) Patent Application Publication
(10) Pub. No.: US 2011/0259380 A1
(43) Pub. Date: Oct. 27, 2011

(54) SOLAR PHOTOVOLTAIC MODULE SELF-CLEANING SYSTEM

(75) Inventor: Pak-Kei LAI, Hong Kong (HK)

(73) Assignee: Du Pont Apollo Limited, Hong Kong (HK)

(21) Appl. No.: 13/090,279

(22) Filed: Apr. 20, 2011

Related U.S. Application Data
(60) Provisional application No. 61/326,236, filed on Apr. 21, 2010.

(51) Int. Cl. B08B 3/00

(52) U.S. Cl. 134/58 R; 134/104.2; 134/198

(57) ABSTRACT

A solar photovoltaic module self-cleaning system includes a plurality of solar photovoltaic module self-cleaning devices. Each solar photovoltaic module self-cleaning device includes a photovoltaic module, a supporting holder and a water distributing portion. The supporting holder at least holds a first side of the photovoltaic module. The water distributing portion is disposed on the supporting holder neighboring to the first side thereof, and should be higher than a light incident surface of the solar photovoltaic module for gushing plural spouts of water abreast to the light incident surface from the first side towards a second side thereof.

### RELATED APPLICATIONS

This application claims priority to U.S. Provisional Application Ser. No. 61/326,236, filed Apr. 21, 2010, which is herein incorporated by reference.

### BACKGROUND

1. Technical Field

The invention relates to a self-cleaning system, more particularly to a solar photovoltaic module self-cleaning system.

2. Description of Related Art

Nowadays, a solar photovoltaic apparatus includes several photovoltaic modules arranged in an array on a roof, and the panels of the photovoltaic modules face towards the sky for receiving sunlight and transferring them into electricity power. Sometimes, dust and dirt are brought with rains or winds to cover on the panels of the photovoltaic modules, thus, capability of power generation drops because of less area of the panels thereof for receiving sunlight. Furthermore, because the photovoltaic modules are installed on a high position such as a roof or a tower, to clean the panels of the photovoltaic modules by manpower could be dangerous.

Therefore, an improved solution other than the conventional way needs to be provided to overcome the problems and inconveniences mentioned above.

### SUMMARY

One objective of the present invention is to provide a solar photovoltaic module self-cleaning system and its solar photovoltaic module self-cleaning device, which can be implemented on dust or dirt cleaning of light incident surfaces of the solar photovoltaic modules, thus, the present invention can keep cleanness of the light incident surfaces to alleviate a drop of the capability of power generation happened.

Another objective of the present invention is to provide a solar photovoltaic module self-cleaning system and its solar photovoltaic module self-cleaning device, which can be operated to clean automatically without manpower, so as to cut down labor cost.

To achieve these and other advantages and in accordance with the objective of the present invention, as the embodiment broadly describes herein, a solar photovoltaic module self-cleaning device includes a photovoltaic module, a supporting holder and a water distributing portion. The photovoltaic module has a light incident surface, a first side thereof and a second side thereof. The first side thereof and the second side thereof are opposite with each other, and the light incident surface is between the first side and the second side thereof. The supporting holder holds at least the first side of the photovoltaic module. The water distributing portion is disposed on the supporting holder neighboring to the first side of the photovoltaic module, and is higher than the light incident surface in altitude. Thus, the water distributing portion gushes a plurality of spouts of water abreast to the light incident surface from the first side thereof towards the second side thereof.

Accordingly, the solar photovoltaic module self-cleaning system and its solar photovoltaic module self-cleaning device according to the present invention effectively maintain the capability of generating power by keeping the light incident surfaces of the solar photovoltaic modules cleaning, and save human resources from manually cleaning the solar photovoltaic modules so as to decrease the labor costs. Furthermore, the present invention decreases a risk that people get injured during cleaning the solar photovoltaic modules when the solar photovoltaic modules are installed on a high position.

### BRIEF DESCRIPTION OF THE DRAWINGS

FIG. 1A illustrates a solar photovoltaic module self-cleaning device according to one embodiment of the present invention.

FIG. 1B illustrates an enlarged view of the water distributing portion along a direction D1 of FIG. 1A.

FIG. 2A illustrates a cross-sectional view taken along line A-A of FIG. 1A according to one modification of the water distributing portion of the solar photovoltaic module self-cleaning device.

FIG. 2B illustrates an enlarged view of the water distributing portion along a direction D2 of FIG. 2A.

FIG. 3A illustrates a cross-sectional view taken along line A-A of FIG. 1A according to another modification of the water distributing portion of the solar photovoltaic module self-cleaning device.

FIG. 3B illustrates an enlarged view of the water distributing portion along a direction D3 of FIG. 3A.

FIG. 4A illustrates a cross-sectional view taken along line A-A of FIG. 1A according to the other one modification of the water distributing portion of the solar photovoltaic module self-cleaning device.

FIG. 4B illustrates a side view showing the water distributing portion without the solar photovoltaic module along a direction D3 of FIG. 4A.

FIG. 5 illustrates a solar photovoltaic module self-cleaning system according to another embodiment of the present invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

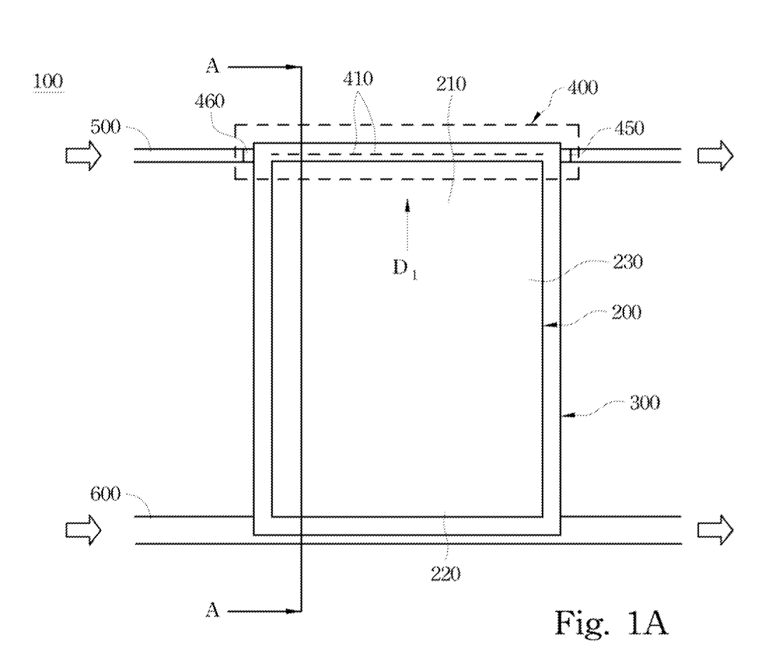

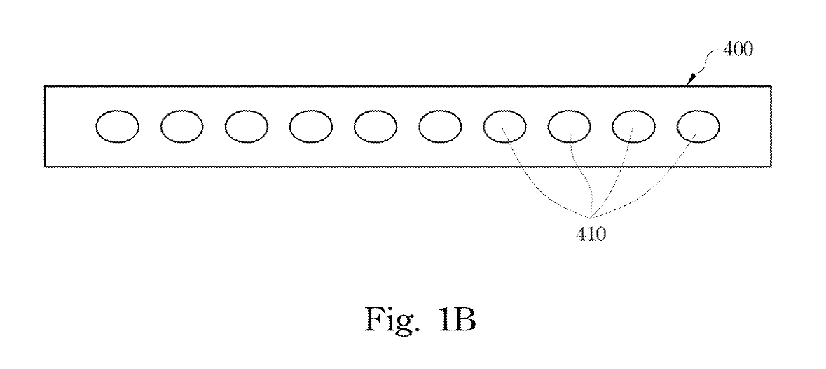

Refer to FIG. 1A and FIG. 1B in which FIG. 1A illustrates a solar photovoltaic module self-cleaning device according to one embodiment of the present invention and FIG. 1B illustrates an enlarged view of the water distributing portion along a direction D1 of FIG. 1A.

The solar photovoltaic module self-cleaning device 100 at least includes a photovoltaic module 200, a supporting holder 300 and a water distributing portion 400.

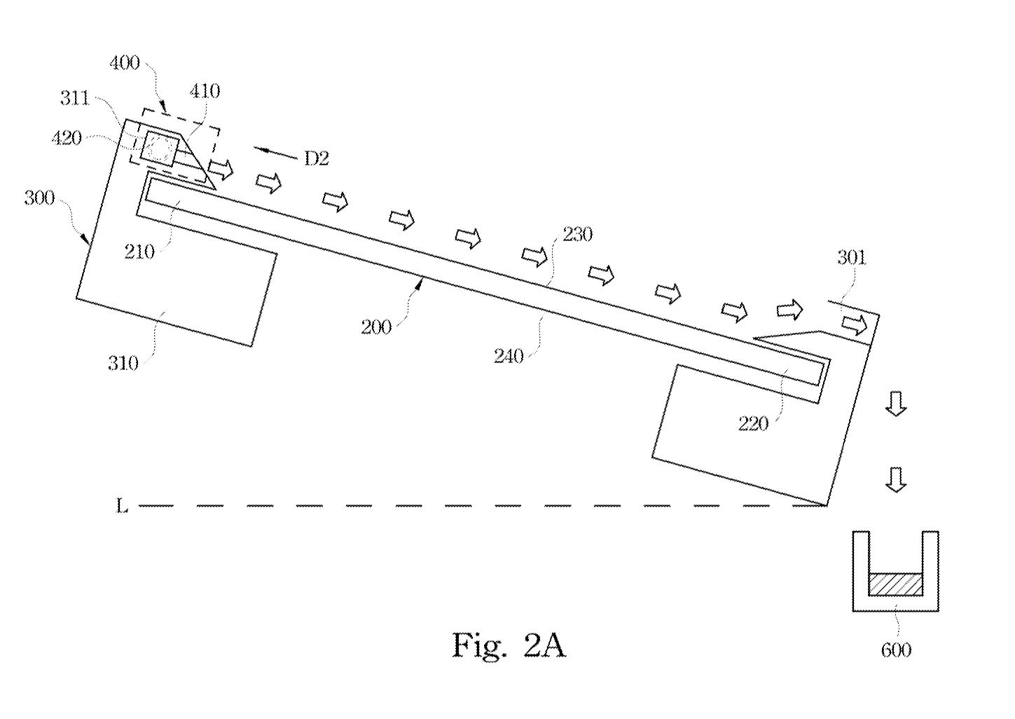

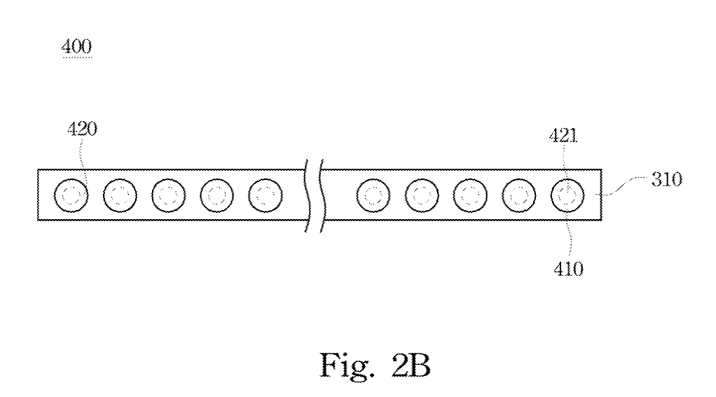

The photovoltaic module 200 is held by the supporting holder 300, and has a first side 210 thereof and a second side 220 thereof in which the first side 210 thereof and the second side 220 thereof are opposite with each other. The photovoltaic module 200 also has a first surface 230 and a second surface 240 (FIG. 2A) thereof opposite with each other. The first surface 230 chosen for facing and receiving lights is called “light incident surface”, and the light incident surface is positioned between the first side 210 and the second side 220 thereof. To be noticed in the invention, the first side 210 and the second side 220 of the photovoltaic module 200 do not limit to be the longer sides or shorter sides (FIG. 1A) of the photovoltaic module 200.

The water distributing portion 400 is disposed on the supporting holder 300 and neighboring to the first side 210 of the photovoltaic module 200, also the water distributing portion 400 is positioned higher than the light incident surface in altitude (FIG. 2A). The water distributing portion 400 has a plurality of water nozzles 410, a water inlet connector 460 and a water outlet connector 450. The water inlet connector 460 is connected to one end of the water distributing portion 400 for communicating with a water feeding canal 500 for receiving a water flow. The water outlet connector 450 is connected to the other end of the water distributing portion 400 for communicating with the water feeding canal 500 for outputting the water flow. The water nozzles 410 are arranged longitudinally on the water distributing portion 400 along an edge of the first side 210 of the photovoltaic module 200.

Thus, the water distributing portion 400 placed above the first side 210 of the photovoltaic module 200 can provide a plurality of spouts of water gushed abreast to clean the light incident surface from the first side 210 thereof towards the second side 220 thereof.

Refer to FIG. 1A, FIG. 2A and FIG. 2B in which FIG. 2A illustrates a cross-sectional view taken along line A-A of FIG. 1A according to one modification of the water distributing portion of the solar photovoltaic module self-cleaning device. FIG. 2B illustrates an enlarged view of the water distributing portion along a direction D2 of FIG. 2A.

Furthermore, the solar photovoltaic module self-cleaning device 100 further has a water recycled canal 600. The water recycled canal 600 is arranged under the second side 220 of the photovoltaic module 200, thus, the water will fall to the water recycled canal 600 from a path 301 of the supporting holder 300 at the second side 220 thereof. Therefore, the water recycled canal 600 thus collects water fallen from the second side 220 of the photovoltaic module 200.

Refer to FIG. 1A, FIG. 2A and FIG. 2B again. In this modification of the embodiment, the supporting holder 300 as in FIG. 1A can be practiced as a first frame 310. The first frame 310 surrounds the photovoltaic module 200, and holds all sides (including the first side 210 and the second side 220) of the photovoltaic module 200. The water distributing portion 400 can be practiced as a hollow channel 311 penetrating through the first frame 310. One end of the hollow channel 311 is connected to the water inlet connector 460, and the other end of the hollow channel 311 is connected to the water outlet connector 450 (FIG. 1A). The water nozzles 410 are arranged on a surface of the first frame 310 and are respectively communicated with the hollow channel 311. Besides, the water nozzles 410 are facing to the second side 220 of the photovoltaic module 200. Thus, the water nozzles 410 can gush a lot of spouts of water abreast from the hollow channel 311 to the light incident surface (i.e. first surface 230).

In an option, a water hose 420 (FIG. 2A and FIG. 2B) can be inserted into the hollow channel 311 and connected with the water inlet connector 460 and the water outlet connector 450 with two opposite ends thereof (FIG. 1A). The water hose 420 is drilled with a plurality of apertures 421 arranged longitudinally, and these apertures 421 are aligned to the water nozzles 410 one by one. Thus, each spout of water can be outputted through one of the apertures 421 and one of the water nozzles 410.

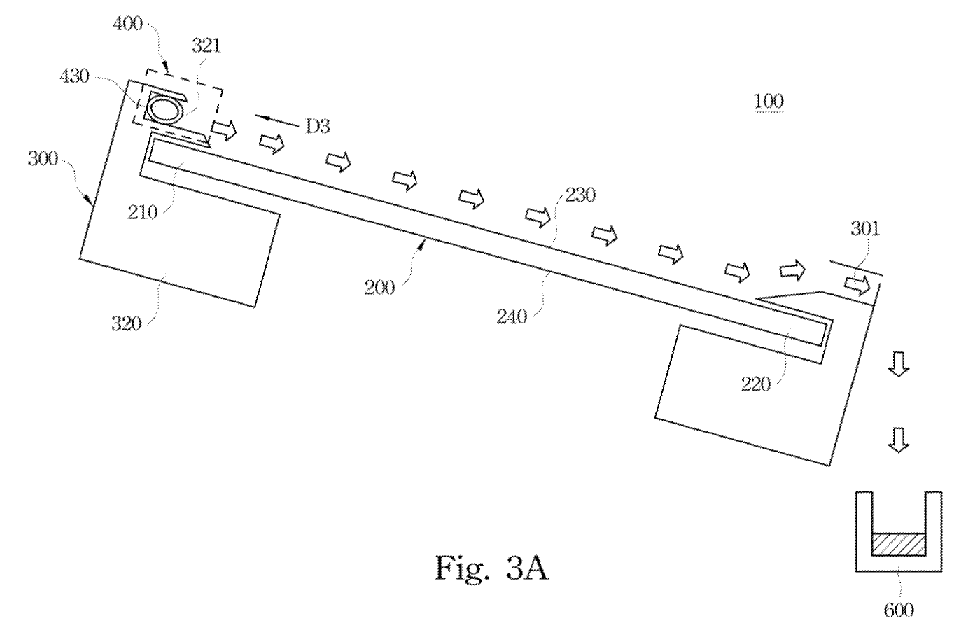

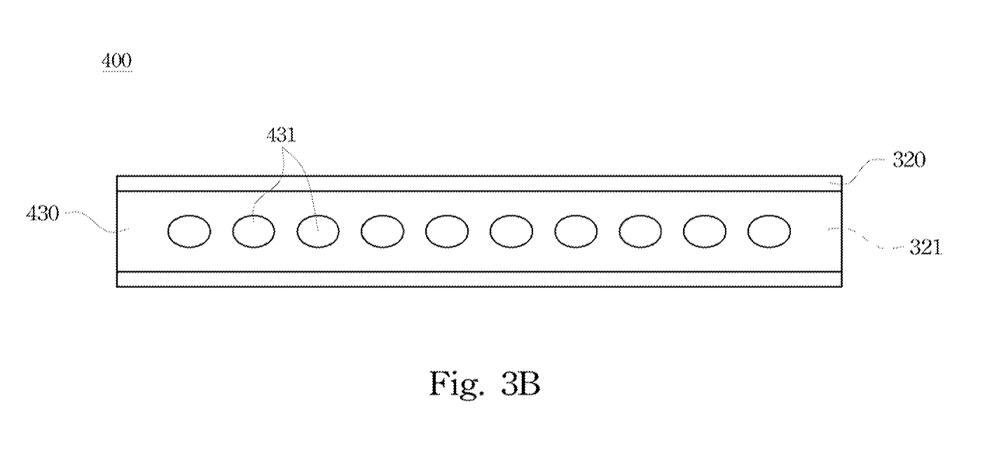

Refer to FIG. 1A, FIG. 3A and FIG. 3B in which FIG. 3A illustrates a cross-sectional view taken along line A-A of FIG. 1A according to another modification of the water distributing portion of the solar photovoltaic module self-cleaning device, and FIG. 3B illustrates an enlarged view of the water distributing portion along a direction D3 of FIG. 3A.

In this modification of the embodiment, the supporting holder 300 can be practiced as a second frame 320. The second frame 320 surrounds the photovoltaic module 200, and holds all sides (including the first side 210 and the second side 220) of the photovoltaic module 200. The water distributing portion 400 can be practiced as an elongate recess 321 and a water hose 430. The elongate recess 321 is arranged on the second frame 320 and neighbors to the first side 210 of the photovoltaic module 200. The water hose 430 can be inserted into the elongate recess 321 and connected with the water inlet connector 460 and the water outlet connector 450 with two opposite ends thereof (FIG. 1A). The water hose 430 is drilled with a plurality of apertures 431 arranged longitudinally, and the apertures 431 are the so called “water nozzles 410 in FIG. 1A” for gushing spouts of water abreast from the water hose 430 to the light incident surface (i.e. first surface 230).

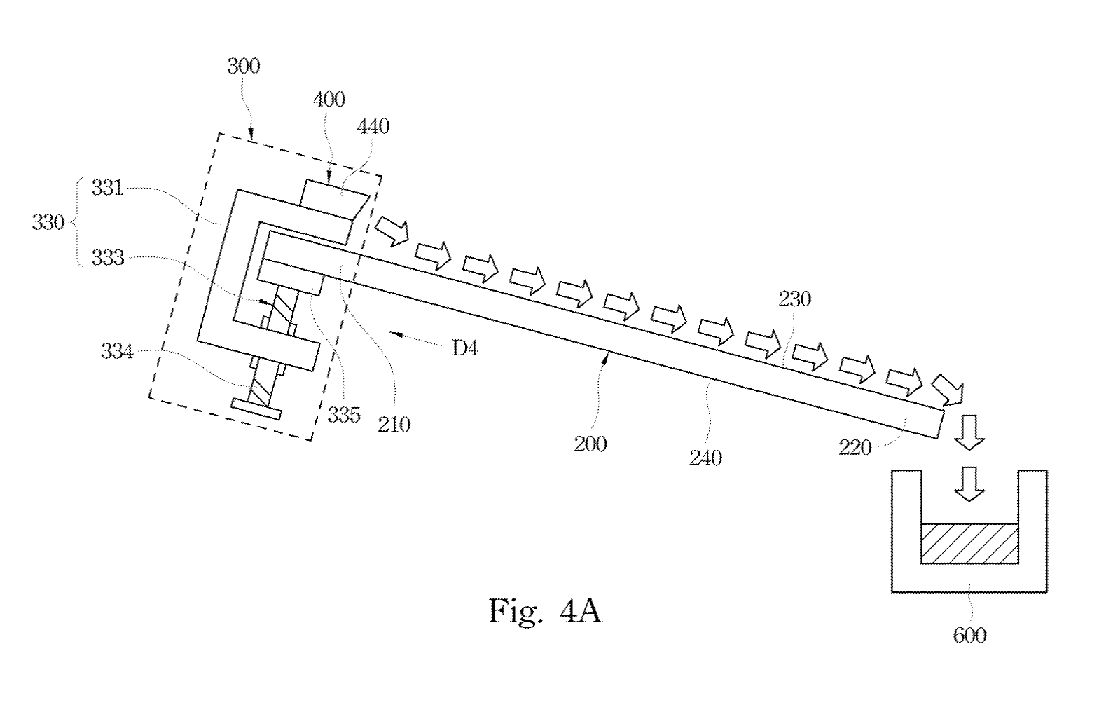

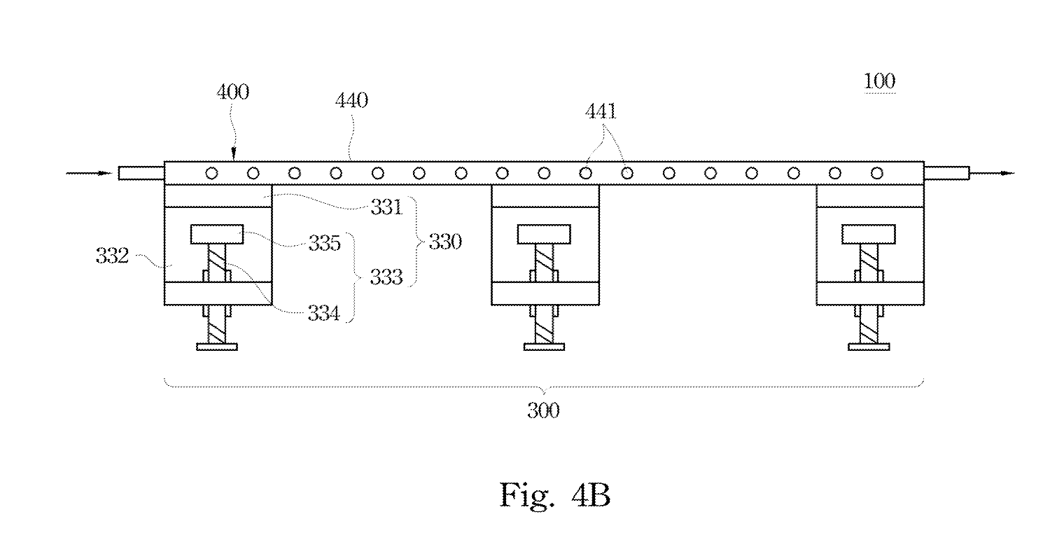

Refer to FIG. 1A, FIG. 4A and FIG. 4B, in which FIG. 4A illustrates a cross-sectional view taken along line A-A of FIG. 1A according to the other one modification of the water distributing portion of the solar photovoltaic module self-cleaning device, and FIG. 4B illustrates a side view showing the water distributing portion without the solar photovoltaic module along a direction D3 of FIG. 4A.

In this modification of the embodiment, the supporting holder 300 can be practiced as a plurality of jigs 330. The jigs 330 are positioned abreast aside the first side 210 of the photovoltaic module 200 (FIG. 4B). Each of the jigs 330 comprises a “C” shaped clamp 331 and a fixing element 333. The “C” shaped clamp 331 is with a receiving space 332 for receiving the first side 210 of the photovoltaic module 200 only. The fixing element 333 is rotatably disposed on the “C” shaped clamp 331, and includes a screw 334 and a press pad 335. The screw 334 is pierced through the “C” shaped clamp 331 into the receiving space 332 with one end thereof. The press pad 335 is disposed on the end of the screw 334 in the receiving space 332.

When the screw 334 is rotated, the press pad 335 is moved to approach the second side 220 of the photovoltaic module 200. The press pad 335 will press the second side 220 of the photovoltaic module 200 and clamp the first side 210 of the photovoltaic module 200 securely, until the screw 334 cannot be rotated any more.

The water distributing portion 400 can be practiced as a hollow pipe 440. The hollow pipe 440 is horizontally disposed on the top of the jigs 330, and is connected with the water inlet connector 460 and the water outlet connector 450 with two opposite ends thereof.

The hollow pipe 440 is drilled with a plurality of water nozzles 441 arranged longitudinally on a surface of the hollow pipe 440 and are respectively communicated with the hollow pipe 440. Besides, the water nozzles 441 are facing to the light incident surface (i.e. first surface 230). Thus, the water nozzles 441 can gush a lot of spouts of water abreast from the hollow pipe 440 to the light incident surface.

In this embodiment, the solar photovoltaic module self-cleaning device 100 can be arranged tilt relative to a horizontal line L, thus, the first side 210 of the photovoltaic module 200 is higher than the second side 220 of the photovoltaic module 200 in altitude. Therefore, the water gushed from the water nozzles 410 will easily flow from the first side 210 of the photovoltaic module 200 to the water recycled canal 600. However, as long as the water pressure of the water gushed from the water nozzles 410 is great enough, the solar photovoltaic module 200 self-cleaning device 100 can be operated to clean the photovoltaic module 200 even through the solar photovoltaic module 200 self-cleaning device 100 is arranged levelly to the horizontal line L.

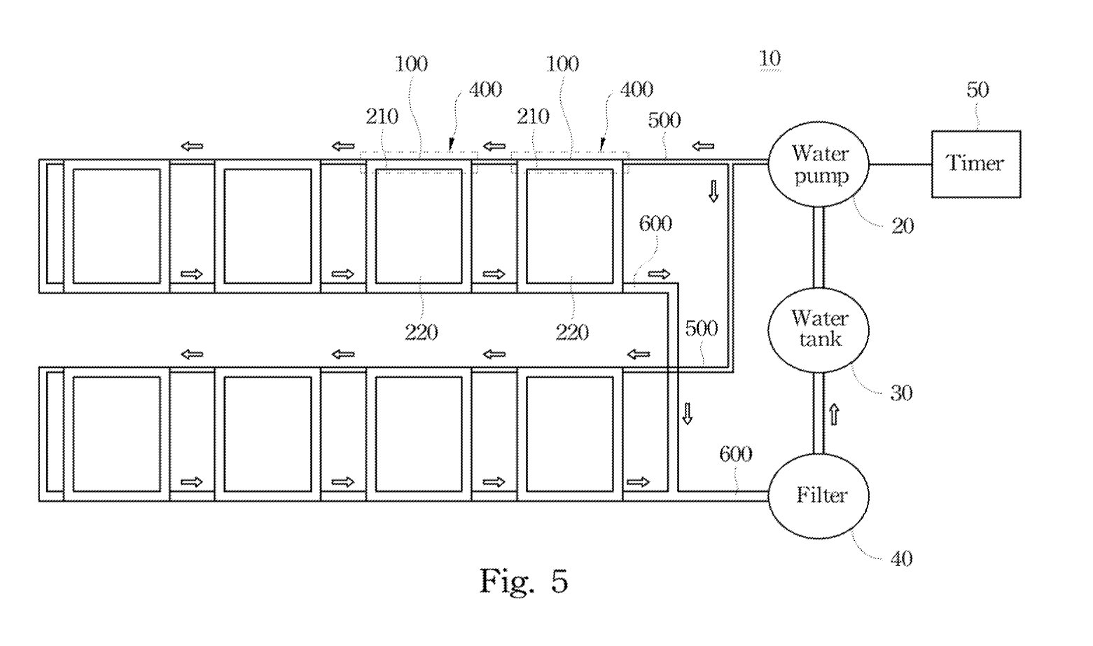

Refer to FIG. 1A, FIG. 1B and FIG. 5 in which FIG. 5 illustrates a solar photovoltaic module self-cleaning system according to another embodiment of the present invention.

In the invention, a plurality of solar photovoltaic module self-cleaning devices 100 mentioned above can be arranged in an array to organize a solar photovoltaic module self-cleaning system 10. A high position as a roof or a tower for the solar photovoltaic module self-cleaning system 10 to install only is an option, the solar photovoltaic module self-cleaning system 10 in the invention need not be limited to install on any place such as on the ground. The water feeding canal 500 mentioned above can be arranged to communicate with all of the water distributing portions 400. The water recycled canal 600 mentioned above can be arranged under all of the second sides 220 of the photovoltaic modules 200 for collecting water from the second sides 220 of the photovoltaic modules 200.

Furthermore the solar photovoltaic module self-cleaning system 10 further has a water pump 20, a water tank 30, a filter 40 and a timer 50. The water pump 20 is connected to the water tank 30 and a front end of the water feeding canal 500. The water tank 30 connected to a terminal end of the water recycled canal 600. The filter 40 is installed between the water tank 30 and the terminal end of the water recycled canal 600. The timer 50 is electrically connected to the water pump 20 for controlling the water pump 20 to work or stop according to a preset time period set by users.

Thus, when the timer 50 turns on the water pump 20, the water pump 20 forces water of the water tank 30 to the water distributing portions 400 via the water feeding canal 500, and the light incident surfaces of the photovoltaic modules 200 are cleaned by water from the water distributing portions 400. After that, the water from the water feeding canal 500, and the water distributing portions 400 will be collected together back to the water tank 30 eventually. Before the water is collected back to the water tank 30, the filter 40 will keep the dust and dirt from the water so as to freshen up the water.

Otherwise, when time is up, the timer 50 turns off the water pump 20, the light incident surfaces of the photovoltaic modules 200 continue to work as usual.

To sum up, the solar photovoltaic module self-cleaning system and its solar photovoltaic module self-cleaning device of the present invention effectively maintain the capability of generating power by keeping the light incident surfaces of the solar photovoltaic modules cleaning, and save human resources from manually cleaning the solar photovoltaic modules so as to decrease the labor costs. Furthermore, the present invention decreases a risk that people get injury during cleaning the solar photovoltaic modules when the solar photovoltaic modules are installed on a high position.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A solar photovoltaic module self-cleaning device, comprising:
a photovoltaic module having a first side and a second side thereof opposite with each other, and a light incident surface between the first side and the second side thereof;
a supporting holder holding at least the first side of the photovoltaic module; and
a water distributing portion disposed on the supporting holder neighboring to the first side of the photovoltaic module, and being higher than the light incident surface in altitude, for gushing plural spouts of water abreast to the light incident surface from the first side thereof towards the second side thereof.

2. The solar photovoltaic module self-cleaning device according to claim 1, wherein the supporting holder is a frame for holding both the first side and the second side of the photovoltaic module.

3. The solar photovoltaic module self-cleaning device according to claim 2, wherein the water distributing portion comprises:
a hollow channel penetrating through the frame and for receiving water with one end thereof, and outputting water with the other end thereof; and
a plurality of water nozzles arranged on a surface of the frame and respectively communicated with the hollow channel, wherein the water nozzles are facing to the second side of the photovoltaic module for gushing spouts of water abreast from the hollow channel to the light incident surface.

4. The solar photovoltaic module self-cleaning device according to claim 3, wherein the water distributing portion further comprises:
a water hose inserted in the hollow channel, having a plurality of apertures arranged longitudinally thereon, wherein the apertures are aligned to the water nozzles by one on one.

5. The solar photovoltaic module self-cleaning device according to claim 2, wherein the water distributing portion comprises:
an elongated recess arranged on the frame, neighboring to the first side of the photovoltaic module; and
a water hose inserted in the elongated recess, receiving water with one end thereof, and outputting water with the other end thereof, wherein the water hose has a plurality of apertures arranged longitudinally thereon, and the apertures are capable of gushing spouts of water abreast from the water hose to the light incident surface.

6. The solar photovoltaic module self-cleaning device according to claim 1, wherein the supporting holder comprises a plurality of jigs positioned abreast aside the first side of the photovoltaic module, and each of the jigs comprises:
a “C” shaped clamp having a receiving space for receiving the first side of the photovoltaic module, and
a fixing element rotatably coupled to the “C” shaped clamp and reaching into the receiving space with one end thereof for being screwed to press and clamp the first side of the photovoltaic module.

7. The solar photovoltaic module self-cleaning device according to claim 6, wherein the water distributing portion comprises:
a hollow pipe horizontally disposed on the top of the jigs, and, for receiving water with one end thereof and outputting water with the other end thereof; and
a plurality of water nozzles longitudinally arranged on a surface of the hollow pipe, and respectively communicated with the hollow pipe, wherein the water nozzles faces to the light incident surface for gushing spouts of water abreast from the hollow pipe to the light incident surface.

8. The solar photovoltaic module self-cleaning device according to claim 1, wherein the first side of the photovoltaic module is higher than the second side of the photovoltaic module in altitude.

9. The solar photovoltaic module self-cleaning device according to claim 1, further comprising:
a water recycled canal arranged under the second side of the photovoltaic module for collecting water fallen from the second side of the photovoltaic module.

10. The solar photovoltaic module self-cleaning device according to claim 1, wherein the water distributing portion comprises:
a water inlet connector connected to one end of the water distributing portion for communicating with a water feeding canal;
a water outlet connector connected to the other end of the water distributing portion for communicating with the water feeding canal.

11. A solar photovoltaic module self-cleaning system comprising:
a plurality of solar photovoltaic module self-cleaning devices arranged in an array, each of the solar photovoltaic module self-cleaning devices comprising:
a photovoltaic module having a first side and a second side thereof opposite with each other, and a light incident surface between the first side and the second side thereof;
a supporting holder holding at least the first side of the photovoltaic module; and
a water distributing portion disposed on the supporting holder neighboring to the first side of the photovoltaic module, and being higher than the light incident surface in altitude, for gushing plural spouts of water abreast to the light incident surface from the first side thereof towards the second side thereof;
a water feeding canal arranged to communicate all of the water distributing portions; and
a water recycled canal arranged under all of the second sides of the photovoltaic modules for collecting water from the second sides of the photovoltaic modules.

12. The solar photovoltaic module self-cleaning system according to claim 11, wherein the supporting holder is a frame for holding both the first side and the second side of the photovoltaic module.

13. The solar photovoltaic module self-cleaning device according to claim 12, wherein the water distributing portion comprises:
a hollow channel penetrating through the frame and for receiving water with one end thereof, and outputting water with the other end thereof; and
a plurality of water nozzles arranged on a surface of the frame and respectively communicated with the hollow channel, wherein the water nozzles are facing to the second side of the photovoltaic module for gushing spouts of water abreast from the hollow channel to the light incident surface.

14. The solar photovoltaic module self-cleaning device according to claim 13, wherein the water distributing portion further comprises:
a water hose inserted in the hollow channel, having a plurality of apertures arranged longitudinally thereon, wherein the apertures are aligned to the water nozzles one by one.

15. The solar photovoltaic module self-cleaning device according to claim 12, wherein the water distributing portion comprises:
an elongated recess arranged on the frame; and
a water hose inserted in the elongated recess, receiving water with one end thereof, and outputting water with the other end thereof, wherein the water hose has a plurality of apertures arranged longitudinally thereon, and the apertures are capable of gushing spouts of water abreast from the water hose to the light incident surface.

16. The solar photovoltaic module self-cleaning device according to claim 11, wherein the supporting holder comprises a plurality of jigs positioned abreast aside the first side of the photovoltaic module, and each of the jigs comprises:
a “C” shaped clamp having a receiving space for receiving the first side of the photovoltaic module, and
a fixing element rotatably coupled to the “C” shaped clamp and reaching into the receiving space with one end thereof for being screwed to press and clamp the first side of the photovoltaic module.

17. The solar photovoltaic module self-cleaning device according to claim 16, wherein the water distributing portion comprises:
a hollow pipe horizontally disposed on the top of the jigs, and, for receiving water with one end thereof and outputting water with the other end thereof; and
a plurality of water nozzles longitudinally arranged on a surface of the hollow pipe, and respectively communicated with the hollow pipe, wherein the water nozzles faces to the light incident surface for gushing spouts of water abreast from the hollow pipe to the light incident surface.

18. The solar photovoltaic module self-cleaning device according to claim 11, wherein the first side of the photovoltaic module is higher than the second side of the photovoltaic module in altitude.

19. The solar photovoltaic module self-cleaning device according to claim 11, wherein the water distributing portion comprises:
a water inlet connector connected to one end of the water distributing portion for communicating with the water feeding canal; and
a water outlet connector connected to the other end of the water distributing portion for communicating with the water feeding canal.

20. The solar photovoltaic module self-cleaning system according to claim 11, further comprising:
a water tank connected a terminal end of the water recycled canal;
a water pump connected to the water tank and a front end of the water feeding canal for providing water to the water distributing portions via the water feeding canal; and
a timer for controlling the water pump to work or stop according to a preset time period.
